(19) United States
(12) Patent Application Publication
(10) Pub. No.: US 2019/0296684 A1
(43) Pub. Date: Sep. 26, 2019

(54) PHOTOVOLTAIC FACADE ELEMENT

(71) Applicant: VINCI CONSTRUCTION, Rueil-Malmaison (FR)

(72) Inventor: Maxime TROCME, Paris (FR)

(73) Assignee: VINCI CONSTRUCTION, Rueil-Malmaison (FR)

(21) Appl. No.: 16/321,391

(22) PCT Filed: Jun. 16, 2017
(86) PCT No.: PCT/EP2017/064752

§ 371 Date: Apr. 25, 2019

(30) Foreign Application Priority Data
Jul. 29, 2016 (FR) 1657366

(51) Int. Cl. H02S 20/23; H02S 20/26; E06B 3/67; E06B 9/24

(52) U.S. Cl. CPC H02S 20/23; H02S 20/26; E06B 2009/2476; E06B 9/24; E06B 3/67

(57) ABSTRACT

A facade or roof element (10), in particular a window, comprising: at least one glazing unit (20); at least one electro-reactive element (22) having optical transparency and/or light-filtering properties that are electrically controllable, and which at least partially overlaps with the glazing unit; at least one photovoltaic panel (32), offset relative to the glazing unit, and providing at least part of the electrical energy required to power the electro-reactive element (22).

The present invention relates to the field of the construction and renovation of buildings for commercial or residential use, and more particularly the faøades or roofings, and the faøade or roofing elements of such buildings, such as the windows. The term “building” should be understood in a broad sense and encompasses fixed-on-land constructions as well as cruise ships.

Electro-reactive glazing units have already been proposed, that make it possible to vary the degree of occulting as a function for example of the level of sunlight. These glazing units are, in some cases, powered by photovoltaic elements incorporated in the glazing.

The article entitled PHOTOVOLTAIC-POWERED EC-WINDOWS (PV-EW) May 2000 NREL/CP-590-28116 thus mentions the benefit of smart glazing units and the possibility of superposing the photovoltaic elements on an electro-chromic glazing unit or arranging them to one side on the frame of the window. In the first case, the superposing of the photovoltaic elements on the electro-chromic glazing unit reduces the transmittance of the electro-chromic glazing unit, which is not desirable in periods of weak sunlight. The second solution, disclosed also in the applications US 2015/378231 and WO 2016/086062, complicates the production of the frame and may be detrimental to the esthetics of the building. In the latter application, the function of the photovoltaic cells is to power ventilation modules.

The video from the company SUNPARTNER Technologies “Wysips Glass 2015”, published on Youtube, shows the use of a photovoltaic component entirely superposed on the glazing unit to supply electrical energy to the latter.

U.S. Pat. No. 6,055,089 discloses a glazing unit in which at least a part of the incident light passes through an electro-reactive element so as to ensure a certain feedback to take account of the sunlight. Such a glazing unit is of complex construction. Furthermore, since the photovoltaic element and the electro-chromic element are arranged between two sealed panes of the glazing unit, any malfunction of one of the elements requires all of the glazing unit to be replaced.

U.S. Pat. No. 5,384,653 discloses a glazing unit incorporating an electro-reactive element and photovoltaic elements between two panes sealed together. The photovoltaic elements are for example arranged in a strip in the top part of the glazing unit. A battery is provided to be recharged by the photovoltaic elements.

The application JP 2004 137852 discloses a liquid crystal screen on which is superposed a solar panel, electrically powering the liquid crystal screen.

The application FR 2 876 840 describes a photovoltaic solar panel that may be used as glazing, comprising light-permeable zones, and assembled with a switchable active film controlling the effects of the solar radiation passing through the panel.

U.S. Pat. No. 5,805,330 describes an electro-reactive glazing unit comprising two panes between which photovoltaic elements are arranged. An electrochrome medium is also present between the two panes in a space closed by a seal.

More recently, it has been proposed, in the U.S. Pat. No. 9,081,246, to power an electro-reactive glazing unit of a window using wireless energy transmission. A photovoltaic element incorporated in the window may supply additional energy. Such a glazing unit in which the energy is provided by radiofrequency for example remains difficult to implement in certain environments.

US 2007/0131270 discloses a window comprising, between two panes, a blind bearing photovoltaic elements. Such a window is complex to produce, because the electrical connections between the photovoltaic elements have to allow the mobility of the blind.

U.S. Pat. No. 6,646,196 describes a window comprising a vertical photovoltaic panel arranged between two clear, left and right, glazing units. The electrical energy supplied by the photovoltaic panel may be used to recharge a lead-acid battery. The installation in a school for teaching purposes is recommended. Such a window does not include any light-occulting mechanism for cases of excessive sunlight.

Moreover, U.S. Pat. No. 8,548,391 describes a photovoltaic installation intended to be installed on the roof of a building and comprising a wireless link radio system for transmitting information concerning the operation of the power electronics associated with a string of photovoltaic elements. This installation may include one or more radio repeaters to extend the range of the communications and neutralize the screen effect of the panels. These repeaters may each be powered by a battery or by a small solar panel.

There is consequently still a need to further refine the windows and other faøade or roofing elements, with electro-reactive glazing, in order to benefit from faøade elements that are at the same time esthetically pleasing, exhibit a relatively high maximum degree of transparency, are capable, if so sought, to address the most stringent energy- and sound-related standards, operate reliably and offer manufacturing and installation costs that are compatible with large-scale marketing.

Thus, the subject of the invention, according to a first of its aspects, is a faøade or roofing element, in particular a window, comprising:
at least one glazing unit,
at least one electro-reactive element whose optical transparency and/or light-filtering properties may be electrically controlled, at least partially overlapping the glazing unit,
at least one photovoltaic panel offset relative to the glazing unit and at least partially supplying the electrical energy necessary to the powering of the electro-reactive element.

“Offset” should be understood to mean the fact that the photovoltaic panel is not superposed on the glazing unit when the latter is observed in a direction at right angles to its plane and is not incorporated between panes of the glazing unit.

The invention may make it possible to produce the window or other faøade element such that the glazing unit and the photovoltaic panel constitute two distinct components that may be replaced independently of one another as required.

The fact that the photovoltaic panel is not superposed with the glazing unit makes it possible to retain a higher degree of transparency in the glazing unit when the latter is in the non-occulted state. This also eliminates any problem of optical interaction between the light reaching the photovoltaic element and that passing through the electro-reactive element and makes it possible to more easily produce the glazing unit and the panel with good thermal performance levels.

The separation of the electro-reactive and photovoltaic functions also simplifies the manufacturing of the window, and in particular may make the production thereof easier with a glazing thickness equal or close to that of conventional windows.

Since the photovoltaic panel is offset, that offers a great degree of freedom esthetically for the production thereof; it may thus easily be produced in the form of an element contributing to the esthetics of the faøade, for example by being arranged in the form of a apron or transom.

It is possible to exploit the presence of a crossmember separating the glazing unit and the photovoltaic panel to conceal the connections between the electro-reactive element and the photovoltaic panel, or between any electronic component such as a battery or driving module and the photovoltaic panel and/or the electro-reactive element.

Electro-Reactive Element

“Electro-reactive element” should be understood to mean an optical component for which it is possible, through an electrical stimulus, to reversibly vary the occulting or light-filtering properties.

“Occulting” should be understood to mean forming an obstacle to the propagation of the visible light, by introducing or not introducing a light filter for certain wavelengths of the visible, infrared and/or ultraviolet ranges. The occulting may be locally total or partial. When it is partial, the light intensity is attenuated on passing through the element. When, locally, the occulting is total, the light which all passes through the electro-reactive element is then that which passes between the locally occulted zones. By acting on the ratio between the occulted surface and the non-occulted surface, it is possible to control the quantity of light passing globally through the electro-reactive element.

“Filtering” should be understood to mean a selective absorption of the light for certain wavelengths. For example, the electro-reactive element may be arranged to vary the transmittance within an IR radiation range in order, for example, to block the IR radiation in summer and to allow it to pass in winter, or to allow it to pass in daytime and to block it in the evening.

It is possible to produce the electro-reactive element in such a way as to be able to separately control, as necessary, the occulting and filtering properties. For example, the electro-reactive element comprises an occulting structure and a filtering structure that may be controlled independently of the occulting structure and superposed thereon.

Multiple electro-reactive element technologies are available, in particular electrochrome (EC), SPD (suspended particle device) or PDLC (polymer dispersed liquid crystal devices). The electro-reactive element is preferably static.

Preferably, the electro-reactive element is clear when idle and takes an occulted state when electrically stimulated. There may be energy consumption only upon a change of state and/or to maintain a state. That may lead to a preference for the EC technology over the SPD technology which is opaque when idle.

The electro-reactive element may comprise an electro-active structure attached to at least one pane, in particular a pane of mineral or organic glass. The production of the electro-reactive element may involve a production method with a step of lamination on the pane.

The electro-reactive element may be arranged between two panes. This element is thus effectively protected from external attacks. It may comprise an electro-active structure embedded between two films of glue between these panes. Preferably, the two panes between which the electro-reactive element is arranged do not form between them a double glazing with air space.

The air space is thus, preferably, formed using at least one additional pane. The fact of arranging the electro-reactive element outside of the double glazing simplifies the production thereof and avoids the issues of sealing of the air space with respect to the output from the electrical connections.

Preferably, the electro-reactive element may take a level of occulting chosen from among several discrete levels, in particular four levels. The level of occulting will for example be 1 to 60%.

The electro-reactive element may comprise only a single zone for which the degree of occulting and/or of filtering may be varied. This zone may cover all or part of the glazing unit.

As a variant, the electro-reactive element has at least two zones that may selectively change the degree of occulting, with a degree of occulting within each zone that is uniform. Thus, it is possible for example to have one of the zones with a degree of occulting different from that of the other zone. A zonal occulting may facilitate the production of a faøade element ensuring an overall transmittance that may be adjusted according to the sunlight, while having a glazing unit that retains an esthetic aspect and preserving the visual comfort of people situated inside the building. The electro-reactive element may have more than two zones that may be selectively controlled, for example three such zones, which may occupy all of the glazing unit or only a part thereof.

When the electro-reactive element is controllable by zones, the latter may have any forms; however, it is advantageous for these zones to extend over all of a dimension of the glazing unit, in particular its width. These zones may in particular each be of rectangular form.

It is also advantageous for these zones to be controlled with a degree of occulting that is variable according to a graded occulting ranging from most occulted to least occulted moving downward. That makes it possible to form a lighter zone toward the bottom of the glazing unit, where the gaze is generally directed, thus conserving the visual comfort.

The electronic means used in controlling the electro-reactive element, such as a control module incorporated in the faøade element, for example, are thus advantageously programmed to convert a request for occulting to a certain level as input, into a control of the different zones so as to generate a corresponding dimming. For example, these electronic means are arranged for the occulting and/or the filtering to be performed first in the highest zone of the glazing unit, and then in the immediately lower zone. The electronic means may be arranged to control the degree of occulting and/or of filtering of the different zones moving downward thus to the lowest zone; the highest zone may be controlled so as to have a greater degree of occulting and/or of filtering, whereas the lowest zones retain a lower degree of occulting. The electronic means may thus, from a certain stage of occulting and/or of filtering, effect the control so as to have a graded occulting and/or filtering. The graded occulting may also be done by progressively increasing the intensity of occulting of all the zones simultaneously.

As a variant, the electro-reactive element is mobile relative to the glazing unit, comprising, for example, a blind, in particular with slats, preferably incorporated in the glazing unit. The orientation thereof may be controlled by an electric motor according to the occulting sought. Other technologies with mobile elements such as micro-slats may also be used.

The output for the connections connected to the electro-reactive element is preferably on the rim.

Photovoltaic Panel

“Photovoltaic panel” should be understood to mean a panel ensuring the production of the electrical energy necessary to power the electro-reactive element to vary its occulting or filtering properties, this energy being generated by the conversion of the incident light energy into electricity.

The photovoltaic panel comprises one or more photovoltaic elements (also called cells) which may be of any photovoltaic technology, in particular mono-crystalline or multi-crystalline or organic silicon-based.

The panel may comprise one or more photovoltaic elements, in a continuous film or discrete cell arrangement.

The photovoltaic panel may be rigid or flexible, being preferably rigid.

Preferably, the photovoltaic panel is planar, but the invention is not limited to a particular geometry and the panel may have a dished form, developable or not.

The panel is preferably glazed, with one and the same pane covering all of the photovoltaic elements.

The panel may be of constant thickness. Preferably, the panel has a parallelepipedal form. The form factor of the panel, defined as the ratio between its height and its width, may be between 0.1 and 10, even better 0.5 and 3.

The height of the photovoltaic panel may be between a third and a half of the height of the glazing unit.

The height of the photovoltaic panel may be between 0.8 m and 1.3 m, even better between 0.9 m and 1.2 m.

The photovoltaic panel belongs, according to the first aspect of the invention hereinabove, to the faøade or roofing element, that is to say that the faøade element forms a whole when it is mounted on the faøade or framework of the building. In the case where the faøade element is a window, the photovoltaic panel is thus borne by the frame of the window when the latter is installed.

According to a second aspect of the invention, the photovoltaic panel is an element that is distinct from the faøade or roofing element, it being, for example, incorporated in another element of the building, in particular a faøade or roofing element, such as a siding, a guard rail, a canopy element, an awning, or a sunshade. This other element may be glazed, and in particular the photovoltaic panel may comprise a pane defining the outer surface thereof, as mentioned above.

The photovoltaic panel may be more or less transparent, even opaque.

When the photovoltaic panel is not opaque, this makes it possible to produce a window which allows more light to pass than if the photovoltaic panel were opaque, which is beneficial for the comfort of the occupants of the premises lit by the window. The photovoltaic panel may have a transmittance of between 5 and 75%.

The non-opacity of the photovoltaic panel may be obtained by arranging its component photovoltaic elements spaced apart, so as to produce apertures within the photovoltaic panel through which the light may pass.

The photovoltaic panel may thus comprise photovoltaic elements arranged in the form of a frame, and for example photovoltaic elements in a strip, arranged parallel to one another and spaced apart.

The non-opacity of the photovoltaic panel may also result at least partly from the use of intrinsically transparent photovoltaic elements, by virtue of the use of non-opaque components.

In a variant embodiment, the photovoltaic panel comprises a decorative layer between the outward-facing side of the faøade element and at least one photovoltaic element.

This decorative layer, visible from the outside, contributes to the esthetics of the panel and more generally to the esthetics of the faøade when the panel is present as faøade. This decorative layer allows light to pass through to the photovoltaic element so that the latter may ensure its electricity production function. The decorative layer is for example a framed, semi-transparent layer. As a variant, the decorative layer is continuous but of a transmittance that is chosen to allow at least a part of the radiation which is converted by the photovoltaic element into electricity to pass.

The decorative layer may be a printed layer. The printing may be done on a pane of the panel and/or on a film incorporated in the panel or covering it on the surface.

The decorative layer may also be obtained by metallization, particularly in a vacuum.

The decorative layer may be a colored tint or define at least one pattern visible to the naked eye.

The decorative layer may possibly be produced in such a way as to filter a part of the spectrum of the incident light energy, for example filter the radiation that is not useful to the production of electricity.

Preferably, the decorative layer is produced so as to visually mask the photovoltaic element or elements and give the panel a uniform appearance. The appearance may also aim to mimic wood or stone.

When the photovoltaic panel is incorporated in a faøade element such as a window, the color of the decorative layer may be chosen to agree with that of the frame, being for example of the same color.

Preferably, the photovoltaic panel comprises double glazing, even triple glazing, in particular when seeking to retain a certain transparency of this panel while having sound and/or thermal insulation properties. Double or triple glazing should be understood to mean a glazing unit comprising at least two panes spaced apart by an air space or defining a space filled by any other gas, at atmospheric pressure or lower. It may be advantageous for the photovoltaic elements not to be present in the air space, to avoid the problems of sealing at the output for the connections.

As a variant, the photovoltaic panel may comprise, rather than double glazing, a thermally insulating sheet, particularly when the panel is opaque.

The photovoltaic panel may incorporate all or part of the electronic control system of the electro-reactive element and a battery making it possible to store the energy produced by the panel.

The panel may comprise any optical structure that makes it possible to concentrate the light on the photovoltaic element or elements, such as an array of microlenses for example.

The electrical efficiency of the photovoltaic panel is for example lower than or equal to 5%; a low efficiency possibly, depending on the technologies used, proving necessary to keep a certain transparency of the panel, when that is desirable.

Faøade Element

The invention applies advantageously to a faøade or roofing element forming a window of the building.

Preferably, the expanse of the glazing unit of the faøade element is greater than that of the photovoltaic panel, so as to benefit from a faøade element of great clarity.

Preferably, the glazing unit of the faøade element incorporates double glazing, even triple glazing.

Preferably, particularly when the faøade element is a window, it is produced with a crossmember which separates the glazing unit and the photovoltaic panel. This crossmember constitutes not only a mechanical means for holding the panel and the glazing unit but contributes also to the esthetics of the faøade element by making the visual contrast between the appearances of the panel and of the glazing unit more easily acceptable.

A faøade element according to the invention may comprise a single glazing unit or several glazing elements distinct from one another, assembled within the element, which is the case for example for an opening with several casements.

The faøade element may comprise several glazing elements and several electro-reactive elements superposed on these glazing elements.

Similarly, the faøade element may comprise one or more photovoltaic panels, which are for example visually separated from one another. For example, the faøade element is a window which comprises only a single photovoltaic panel as apron or, as a variant, as transom. In a variant, the faøade element is a window which comprises two photovoltaic panels, one as apron, the other as transom.

The faøade element may comprise any conventional ornamental element such as, for example, cross-pieces.

It is particularly advantageous for the faøade element to comprise a battery for storing the energy generated by the photovoltaic panel. This battery is for example of NiMH type, and its capacity is for example greater than or equal to 2 Wh. That makes it possible to control the electro-reactive element outside of the periods of sunlight. Preferably, the faøade element comprises an external connector allowing it to be recharged. The recharging may also be effected, if necessary, by inductive coupling.

The battery may be housed, when the faøade element is a window, in the frame of this window.

The battery is preferably housed in a housing that is accessible from the inside of the building without dismantling the faøade element. This housing is for example arranged at the level of the photovoltaic panel, being for example present in the bottom part of the faøade element, when the photovoltaic panel is arranged as apron.

The battery is preferably mounted without the creation of thermal bridges.

Preferably, access to the battery is possible without dismantling the faøade element; through the removal of a hatch or of a cover, with or without tools such as a screwdriver.

It is also advantageous for the faøade element to comprise a wireless control module for the electro-reactive element, for example incorporated in the glazing unit or incorporated in a frame of the faøade element, in particular incorporated in the frame in the case of a faøade element forming a window, or housed in a housing secured to the faøade element and accessible from the inside of the building. This housing may in particular be situated in the bottom part of the window, being for example adjacent to the bottom crossmember of the window. The battery and the control module may be situated in one and the same housing.

The faøade element may incorporate a converter arranged to bring the voltage produced by the photovoltaic panel to a level compatible with the charging of the battery.

It is advantageous to use the photovoltaic panel as sunlight sensor, particularly to ensure, if that is sought, an automatic control of the electro-reactive element as a function of the sunlight. The use for each faøade element of the photovoltaic panel of this faøade element to control the electro-reactive element makes it possible to control the occulting and/or the filtering with a low grading and thus be able to take account of cast shadow effects for example.

If appropriate, the control module of each faøade element is produced so as to be able to define a master element and one or more slave elements. The photovoltaic panel of the master element may be used as sunlight sensor and the electro-reactive elements of the slave faøade element or elements are controlled as a function of the information transmitted by the master element.

The control modules of the faøade elements may be arranged to communicate with one another by a wireless link.

All the faøade elements may comprise an identical control module. As a variant, the faøade is for example produced with faøade elements having more sophisticated control modules, used as masters, and more simple control modules, used as slaves.

Preferably, the faøade element comprises a control module which may be controlled by a mobile terminal such as a smartphone or a tablet. This control module is electrically powered by the photovoltaic panel.

The control module may also be controlled by a centralized control device ensuring the thermal regulation of the building.

It may be advantageous for the faøade element to comprise a connector making it possible to use a surplus of energy from the photovoltaic panel for other functions of the building and to return energy to the power grid.

The electricity produced by the photovoltaic panel may also be used to power various sensors such as brightness, motion, presence or pollution sensors, or to control an electrical lock or a badge reader.

In an exemplary implementation, the faøade element may comprise a radio relay powered at least partially by the photovoltaic panel. Such a relay comprises a receiver for receiving a radiofrequency signal and a transmitter for retransmitting it, for example at a different frequency and/or with a different coding. That may make it possible to relay the radiofrequency information transmission, between connected objects for example. One possibility is thus to equip at least some faøade elements of the building with such radio relays so as to allow the wireless control of all of the faøade elements from a single transmitter, belonging for example to a building regulation unit.

The transmitter and/or the receiver of the radio relay can, if necessary, share certain components of the control module, in particular those of the radiofrequency stage making it possible to transmit and receive instructions concerning the operation of the electro-reactive element. The radio relay function may then be produced more economically.

If necessary, the control module comprises a processor which manages both the operation of the electro-reactive element and that of the radio relay.

In an exemplary implementation of the invention, the faøade element comprises at least one electronic device such as a screen or another light device, incorporated in the faøade element, in particular in the glazing unit, and powered by the photovoltaic panel.

This screen is used to display information concerning the operation of the faøade element such as, for example, the degree of occulting, the electrical energy produced, the level of charge of the battery, or an error code.

The screen may also be used, as a variant or in addition, to display at least one piece of information concerning the environment, such as, for example, the current or setpoint temperature, the relative humidity, the weather or transport forecasts and more generally any useful information.

The light device may be used to change the appearance of the faøade or of the room that the glazing unit gives onto, by emitting a given color.

The term screen covers any display device or light emitter. The screen technology may be of LED, OLED or liquid crystal type, among others.

The invention is not limited to a particular form for the glazing unit. The latter is, however, preferably between 0.2 and 10 m high.

The faøade or roofing element may have no pane shared between the photovoltaic panel and the glazing unit.

Yet another subject of the invention, according to another of its aspects, independently of or in combination with the above, is a faøade or roofing element, in particular a window, comprising a glazing unit, an electro-reactive element being at least partially superposed on the glazing unit, and at least one photovoltaic panel powering a control module of the electro-reactive element, the glazing unit and the photovoltaic panel being separated by a crossmember of a frame of the faøade element. This crossmember may comprise electrical connections to the electro-reactive element and/or the photovoltaic panel. The faøade element may comprise, preferably on its interior side, a housing housing the control module and/or a battery storing energy produced by the panel. The latter may be arranged as a apron or as a transom on the faøade element.

Faøade

Yet another subject of the invention is a faøade of a building comprising at least one faøade element according to the first aspect of the invention, as defined above. The photovoltaic panels may also contribute to the thermal insulation, even sound insulation of the faøade.

The use of photovoltaic panels distributed over the faøade may be advantageous also to simplify the electrical connections, a photovoltaic panel being, for example, used to power two electro-reactive elements associated with two windows between which the panel is placed; a panel forming a siding element is for example used, arranged between two windows to power the electro-reactive elements thereof. It is also possible to use a photovoltaic panel arranged as apron to electrically power two windows that are vertically superposed.

Methods

Yet another subject of the invention is methods implementing in particular a faøade element according to the first aspect of the invention or a faøade according to the second aspect of the invention.

Thus, yet another subject of the invention, according to another of its aspects, is a method for contributing to ensuring the thermal regulation of a building comprising at least one faøade element, in particular a window, provided with a glazing unit on which is at least partially superposed an electro-reactive element whose occulting and/or filtering properties may be controlled, in which the electrical energy produced by at least one photovoltaic panel incorporated in the building is used to electrically power the electro-reactive element in order to modify its occulting and/or filtering properties.

This photovoltaic panel may be incorporated or not in the faøade element depending on whether the aim is to exploit the first aspect of the invention presented above or not. This photovoltaic panel may be incorporated in another faøade element such as a siding, a guard rail, a sun shade or an awning for example, as mentioned above.

The photovoltaic panel may be arranged so as to allow light to enter into the building.

The thermal regulation may be effected autonomously with control of the electro-reactive elements according to a predefined control law. This law may make it possible to clip the incident solar energy when the latter crosses a predefined threshold, set for example between 30 and 50 W/m². Thus, the occulting may be zero for example if the incident solar energy is below a given value, for example 40 W/m².

In an exemplary implementation, the surplus of electrical energy supplied by the photovoltaic panel or panels is returned to the grid or used for other functions such as, for example, the radio relay function or the function of powering screens or light devices aiming to color the faøade at night, for example.

Yet another subject of the invention is a method for managing a degree of occulting of at least one glazing unit by an electro-reactive element controlled by a control module at least partially powered by a photovoltaic panel, in which the photovoltaic panel is used as sunlight sensor.

The panel may be used as sensor on the scale of one electro-reactive element associated with one faøade element, or, as a variant, be used to control a group of electro-reactive elements associated with as many glazing units.

Yet another subject of the invention, according to another of its aspects, independently of or in combination with the above, is a method for varying the degree of occulting of a glazing unit of a faøade element, using at least one electro-reactive element powered by at least one photovoltaic panel, the electro-reactive element being able to be controlled by zones, in which the occulting of the different zones is controlled so as to obtain, at a given moment, a graded occulting with a higher degree of occulting at the top than at the bottom. The grading may be limited to two zones, if necessary.

The glazing unit may be arranged in such a way that it retains a zone with is never occulted. As a variant, all the glazing unit is occulted, for example with variable levels from one zone to another.

Screen

Another subject of the invention, according to another of its aspects, independently or in combination with the above, is a faøade or roofing element, in particular a window, comprising at least one photovoltaic element and a screen electrically powered at least partially by the electricity produced by the photovoltaic element. Preferably, this faøade or roofing element comprises an electro-reactive element powered at least partially by the photovoltaic element. The screen may receive data to be displayed concerning the operation of the electro-reactive element or of the photovoltaic element.

Radio Relay

At least one of the photovoltaic elements advantageously powers a radio relay. “Radio relay” denotes any electronic transceiver device capable of receiving an incident radio signal and transmitting a radio signal to, for example, another radio relay or a climate regulation unit of the building.

The radio relay may constitute a radio signal repeater, allowing exchanges of information with the faøade or roofing elements without requiring wiring to transmit the information or power the relays. Furthermore, it is possible to perform a fine and automatic control of the different electro-reactive elements, to take account for example of the variations of sunlight of the faøade or the roof, linked for example to the orientation with respect to the sun according to the time of day and/or to cast shadows, while observing the climate requirements of the building, by virtue for example of the exchanges of information with a climate regulation unit of the building.

The frequency is for example of the order of a few hundreds of MHz or of a few GHz. Preferably, the signals received and transmitted are digital. The signals are for example of Wifi or Zigbee type.

Thus, according to another of its aspects, independently or in combination with the above, another subject of the invention is a building faøade or roofing, comprising at least one photovoltaic element incorporated in the faøade or in the roofing and at least one radio relay powered at least partly by the electricity produced by the photovoltaic element. The presence of the photovoltaic element incorporated in the faøade or in the roofing is exploited to power the radio relay; the need to provide specific electrical power supply means is thus avoided, which simplifies the installation of the relay and preserves the esthetics of the building. Furthermore, the radio relay may be produced, if so desired, so as to receive information concerning the level of lighting of the photovoltaic element in order to transmit this information to a thermal regulation unit of the building. The radio relay is then used in a dual function, as radio repeater making it possible to extend the range of the exchanges of data between various connected objects of the building, and as transmitter of information linked to the lighting of the photovoltaic elements, which may provide information on the incident heat fluxes at various points of the building.

The faøade or roofing may comprise a glazing unit and at least one electro-reactive element superposed at least partly on the glazing unit.

The radio relay may advantageously be arranged to receive and retransmit at least one item of information concerning the remote control of the electro-reactive element. That may make it possible to very easily control an assembly of electro-reactive elements in a centralized manner from a thermal regulation unit of the building for example, without having to deal with electrical wiring problems since the relays are autonomous energy-wise, as are the electro-reactive elements. This control is advantageously performed by taking account of the local lighting by virtue of the use of the photovoltaic elements as sunlight sensors, and in this way it is possible to finely control the incident heat fluxes in the building. It is in particular possible to avoid pointlessly darkening a glazing unit that is not lit by the sun, for example because of its exposure and/or a cast shadow phenomenon.

The faøade or roofing may comprise several photovoltaic elements and several radio relays powered at least partially by these photovoltaic elements, at least one of the radio relays receiving information concerning the control of an electro-reactive element and retransmitting it to another radio relay.

The photovoltaic element is advantageously used as lighting sensor and information concerning the level of lighting of the photovoltaic element being transmitted by the radio relay.

The faøade or roofing may comprise several photovoltaic elements and several radio relays powered at least partially by these photovoltaic elements, at least one of the radio relays receiving information concerning the level of lighting of a photovoltaic element and retransmitting it to another radio relay.

The control of the electro-reactive elements is performed preferably at least on the basis of information concerning the lighting of the photovoltaic elements.

Another subject of the invention, according to another of its aspects, independently or in combination with the above, is a faøade or roofing element, in particular for producing a faøade or a roofing as defined above, comprising at least one photovoltaic element and at least one radio relay electrically powered at least partially by the photovoltaic element. The faøade or roofing element may comprise a glazing unit and preferably constitutes a window.

The faøade or roofing element may comprise a control module of the electro-reactive element, the radio relay being configured to allow the control module to exchange data with a remote terminal such as a cellphone. That may allow a person situated in a room of the building to take control of the state of the electro-reactive element, if there is a desire for example to force its transition to an occulted or clear state for various reasons, for example linked to the presence of reflections on computer screens. The use of the radio relay in this function makes it possible to avoid the use of a specific transceiver and facilitates the miniaturization of the electronics and the locating thereof in a frame of the faøade or roofing element, for example.

Another subject of the invention, according to another of its aspects, independently or in combination with the above, is a method for controlling electro-reactive elements of a faøade or of a roofing comprising several electro-reactive elements powered by photovoltaic elements, in which a signal controlling the filtering and/or the occulting of the electro-reactive elements is transmitted from a climate regulation unit of a building to one or more of the electro-reactive elements via one or more radio relays powered by at least one of said photovoltaic elements.

In such a method, one or more of said photovoltaic elements is advantageously used as sunlight sensor and information concerning the sunlight of the photovoltaic elements is transmitted to the regulation unit via one or more of said radio relays, as mentioned above.

The degree of occulting and/or of filtering of the electro-reactive elements is preferably adjusted automatically according to the information concerning the sunlight, in particular to reduce the degree of occulting and/or of filtering of the electro-reactive elements subject to the least sunlight. Preferably, the electro-reactive elements are superposed at least partially on the photovoltaic elements or the photovoltaic elements are offset relative to the electro-reactive elements, being preferably adjacent, in particular belonging to one and the same faøade or roofing element, in particular one and the same window, the photovoltaic element belonging for example to a photovoltaic panel arranged as apron, as explained above.

The invention will be able to be better understood on reading the following detailed description of nonlimiting exemplary implementations thereof, and on studying the attached drawing, in which:

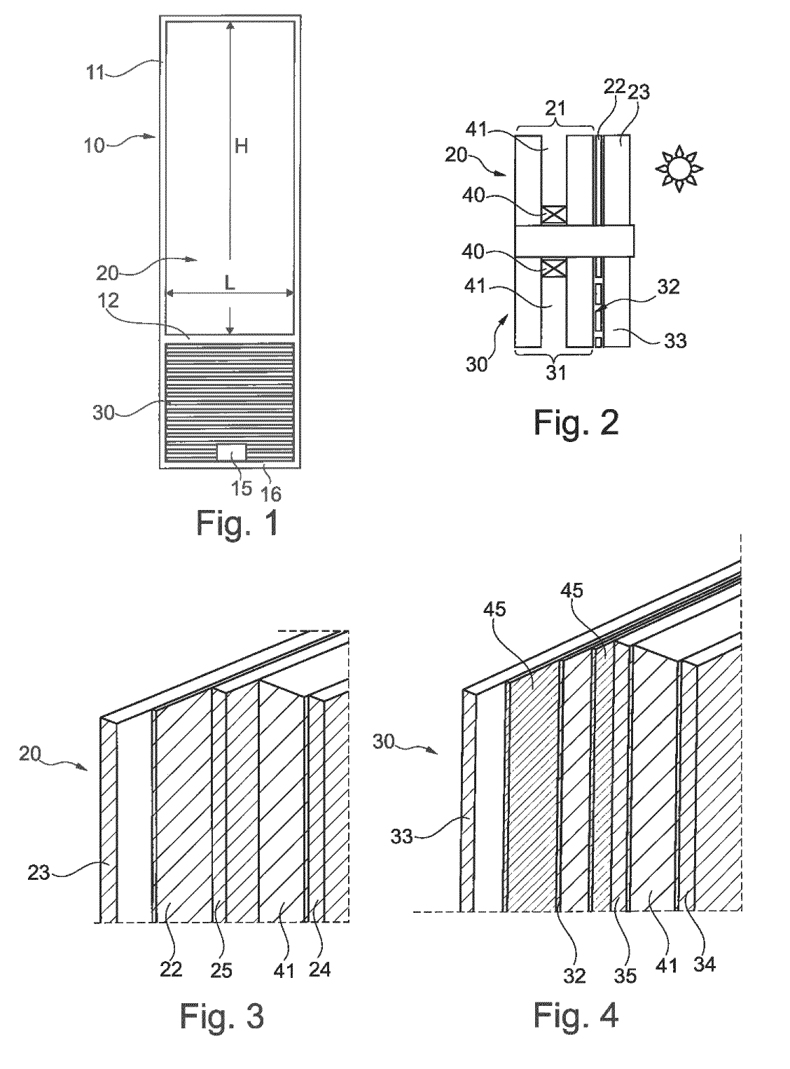

FIG. 1 represents, in a front view, an example of a window produced in accordance with the first aspect of the invention,

FIG. 2 schematically and partially represents the structures of the electro-reactive glazing unit and of the photovoltaic panel of the window of FIG. 1,

FIGS. 3 and 4 are perspective, schematic and partial views, respectively of the structure of the electro-reactive glazing unit and of the photovoltaic panel,

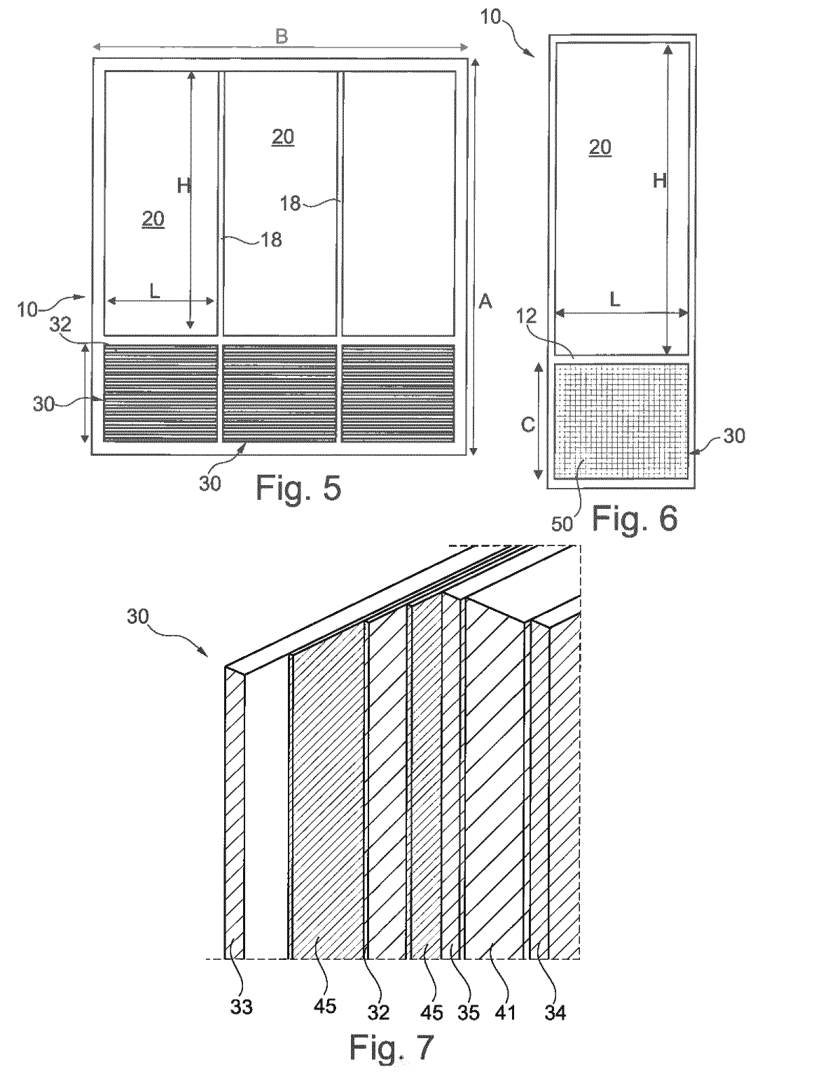

FIGS. 5 and 6 represent variants of faøade elements according to the invention,

FIG. 7 is a view similar to FIG. 3 illustrating a variant embodiment of a photovoltaic panel,

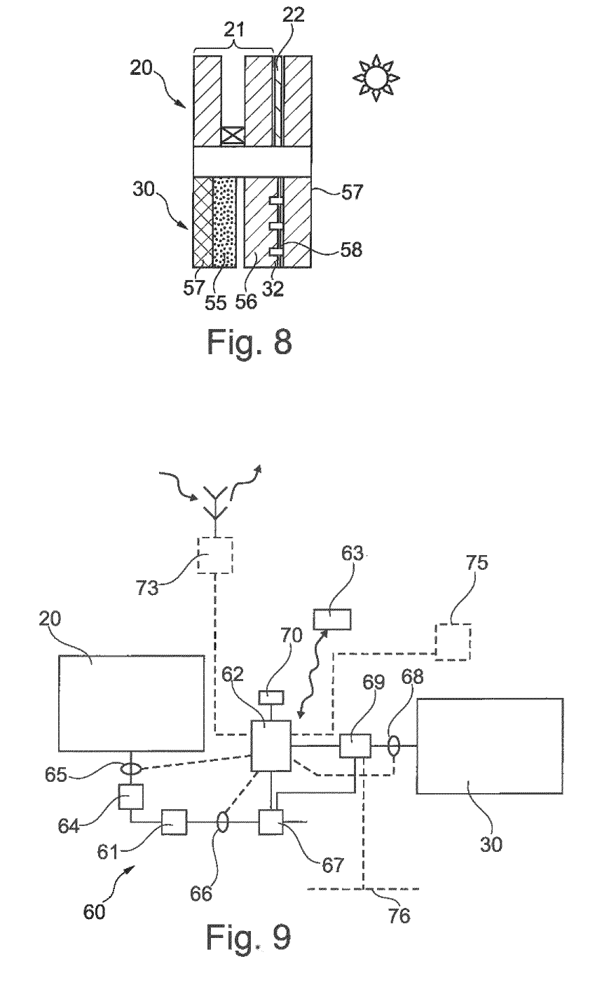

FIG. 8 is a view similar to FIG. 2 of another variant embodiment of the photovoltaic panel,

FIG. 9 is a schematic view of an example of an electronic control system of the electro-reactive element,

FIGS. 10 and 11 represent variant embodiments of windows according to the invention, and

FIG. 12A represents an example of a faøade according to the invention.

The window 10 according to the invention, represented in FIG. 1, comprises an electro-reactive glazing unit 20 and an associated photovoltaic panel 30, arranged as apron in the example considered.

The window 10 comprises a frame 11 which is for example a fixed or mobile frame. The term “window” should not be understood as limiting, and covers windows installed equally as “new installation”, and renovation or restoration installation.

The form of the frame 11 may be rectangular, as illustrated, the invention not however being limited to a particular frame shape, the latter being able to be trapezoidal, triangular or arched among other forms. The window can, when the frame is not fixed, have a sash or several sashes. If appropriate, the window constitutes a French window.

The frame 11 of the window may be metal, in particular made of aluminum or of aluminum alloy, or of plastic, in particular of PVC, even of wood.

The frame 11 of the window 10 comprises conventional hinging, and if necessary a closure system allowing the window to be locked. The appearance of the frame may be the same as that of conventional joinery work.

The window 10 comprises, in the example considered, a crossmember 12 which separates the glazing unit 20 from the photovoltaic panel 30.

From its interior side, the window 10 comprises, in the example illustrated, a housing 15 which houses a battery and an electronic control module, as will be specified hereinbelow. This housing 15 is fixed in the example considered in the bottom part of the window, adjoining the bottom crossmember 16.

Referring to FIG. 2, it may be seen that both the glazing unit 20 and the photovoltaic panel 30 comprise respective double glazings 21 and 31, which ensure thermal and sound insulation. Schematically represented in this figure are double glazing seals 40, which make it possible to form air spaces 41. The air spaces 41 of the photovoltaic panel 30 and of the glazing unit 20 are not interconnected. The different panes of the glazing unit 20 are superposed on at least one electro-reactive element 22 situated on the outside of the double glazing 21, that is to say that facing outward from the building which receives the incident light. This or these electro-reactive elements 22 are protected on the outside by a pane 23. Similarly, the photovoltaic panel 30 comprises one or more photovoltaic elements 32 which are arranged on the outside of the double glazing 31 and protected from the outside by at least one pane 33.

The structure of the glazing unit 20 is represented otherwise in FIG. 3. It may be seen that the double glazing may be formed between two panes 24 and 25 in glass 4 millimeters thick for example, the electro-reactive element or elements 22 being arranged between the pane 25 and the pane 23, which is for example glass also 4 millimeters thick.

Concerning the photovoltaic panel 30, it may be seen on studying FIG. 4 that the double glazing may be formed between panes 34 and 35 for example composed of glass 4 millimeters thick.

The photovoltaic element or elements 32 may be arranged between the pane 35 of the double glazing and the outer pane 33, a film of glue 45 being able to be inserted between the photovoltaic element or elements 32 and each pane 33 or 35. The thickness of the panes 33, 34 and 35 is for example 4 millimeters. The glue is for example a PVB glue.

If appropriate, as illustrated in FIG. 5, the faøade element may be a window 10 comprising mullions 18 which divide it for example into three vertical parts that may or may not be equal. Each vertical part comprises a glazing unit 20 provided with an electro-reactive element and a photovoltaic panel 30 arranged as apron. A apron arrangement proves particularly advantageous for countries with strong sunlight.

The heightwise and widthwise dimensions of a window with a glazing unit are for example between 2.4 and 2.6 m for the height H and between 1.2 and 1.4 m for the width L; the height A and the width B of the frame of a window 10 as represented in FIG. 5 are for example between 2.4 and 2.6 m for the height A and between 3.5 and 4.5 m for the width B.

The electro-reactive elements or elements 22 are for example those developed by the company SAGE GLASS. These elements may be supplied already associated with a glazing unit.

In the variants of FIGS. 1 to 5 the photovoltaic panel 30 is not fully opaque, having a non-zero transmittance.

The photovoltaic element or elements are for example those of CIGS technology. These elements may be arranged in the form of a frame making it possible to form between them apertures allowing a part of the incident light to pass. The photovoltaic elements may in particular be arranged as illustrated in the form of parallel strips spaced apart.

In the variant faøade element illustrated in FIG. 6, the photovoltaic panel is no longer transparent but opaque, further comprising at least a visible decorative layer masking the appearance of the underlying photovoltaic element or elements. The panel 30 may be in the form of a apron, as illustrated, and the decorative layer may give the panel the same appearance as that of an adjacent siding element, for example. The height C of the photovoltaic panel 30 may be between 0.8 m and 1.3 m.

Referring to FIG. 7, it may be seen that the panel 30 may comprise a double glazing having a pane 35 which is for example composed of transparent glass 4 millimeters thick as in the example of FIG. 4, and an outer pane 34 which, unlike the example of FIG. 4, may be composed of opaque glass 4 millimeters thick. The decorative layer 58 may be situated level with the photovoltaic elements 32, superposed on the latter and situated between the films of glue 45.

It is possible, in particular when it is opaque, to produce the photovoltaic panel 30 in various other ways and in particular, as illustrated in FIG. 8, with a sheet of an insulating material 55 arranged behind a pane 56 against which the photovoltaic elements 32 rest. A cladding 57 may enclose the panel 30 at the back.

Preferably, the photovoltaic panel 30 is sufficient to provide all the energy necessary to the operation of the faøade element in which it is incorporated, that is to say the energy for changing the state of the electro-reactive element and the energy for operating the control module. The faøade element may thus, if so desired, have autonomous operation.

An electronic system 60, represented schematically in FIG. 9, is provided to ensure the management of the operation of the faøade element.

This operation may be totally autonomous at the level of the faøade element, which then operates according to a predefined control law dependent on sunlight, but preferably, the electronic circuit system 60 is produced in such a way that the faøade element may operate either in a totally autonomous mode in which it, for example, clips the solar energy above a certain threshold, or in a mode with external control, this control being either manual, or ensured by a centralized control device of the building.

The electronic system 60 comprises a battery 61 which makes it possible to accumulate the electrical energy generated by the photovoltaic panel 30 during periods of illumination.

The electronic system 60 also comprises a control module 62 which manages the exchanges between the photovoltaic panel 30 and the associated electro-reactive element, and may communicate with an external device 63 by a wireless link, for example radiofrequency or infrared.

The electronic system 60 may comprise a converter 64, for example of DC-DC type, between the battery 61 and the photovoltaic panel 30, so as to adapt the voltage delivered by the photovoltaic element or elements to that of the battery.

If necessary, as illustrated, a current and/or voltage reading at 65 may inform the module 62 on the level of production of the panel 30. A voltage and/or current reading at 66 may also inform the module 62 on the level of charge of the battery 61 and, if necessary, on the intensity of the current output by the latter. If necessary, as illustrated, a conversion stage 67 may be provided downstream of the battery 61 in order to adapt the output voltage to that required by the control module 62 and by the electro-reactive element 22. A voltage and/or current reading at 68 may inform the module 62 on the state of operation of the electro-reactive element. A switching circuit 69 may be actuated by the control module 62 to supply the necessary electrical energy to the electro-reactive element 22 according to the desired degree of occulting.

The electronic system 60 may comprise a manual control interface 70, if appropriate. This control interface may be produced in various ways, for example in the form of a button to be actuated or of a touch command zone based on capacitive detection for example. The manual control interface may make it possible to control in particular the degree of occulting of the glazing unit 20.

The external device 63 may be a mobile terminal such as a cellphone or a smartphone, running a suitable application making it possible in particular for the user to set the level of occulting of the glazing unit 20 and know, as appropriate, the state of charge of the battery 61, the selected level of occulting and/or receive any error code signaling a malfunction of the electronic system. The control module may thus be arranged to provide feedback on the different operating parameters of the faøade element and to define operating scenarios based on information from various sensors.

It may be advantageous to provide the faøade element with a radio relay function for example to relay the transmission of information between control modules of faøade elements and/or between a centralized control module and several faøade elements. It may even involve relaying information transmitted by other connected objects, belonging to the building or not, for example information concerning temperature or energy consumption sensors or informing on the presence of occupants.

The electronic system 60 may thus comprise a transceiver assembly 73 making it possible to pick up an incident signal and retransmit a corresponding signal after optionally boosting to a different frequency. This transceiver assembly may operate as UNB, Bluetooth, Wifi, Zigbee, Enocean, or other such repeaters, and may share RF components used for the remote control of the faøade element and the control module 62 for the decoding/coding of the retransmitted information, if appropriate. The radio relay 73 may be configured to transmit, to a thermal regulation unit of the building, information concerning the occulting and/or filtering state of the associated electro-reactive element and the local level of sunlight of the associated photovoltaic panel and receive in return from the regulation unit an instruction concerning the level of occulting and/or of filtering to be given to the electro-reactive element in order to comply with a predefined thermal regulation law. The thermal regulation unit of the building may manage all of the building; as a variant, the building comprises several regulation units, associated for example with respective portions of the building such as certain offices, residences or floors. If appropriate, a regulation unit is provided for each room. Preferably, the faøade or roofing elements are programmable in such a way that they may be paired with a predefined regulation unit.

The electronic system 60 can, if so desired, and if the energy supplied by the photovoltaic panel permits, power other devices such as a screen 75 used for example to display information concerning the state of operation of the faøade element.

The electronic system 60 may even be produced, if appropriate, in such a way as to return a surplus of energy produced by the panel 30 to a collection bus 76 linked to the grid or used to power other devices of the building.

The electro-reactive element 22 may have a degree of occulting which may vary continuously between two extreme levels, or by stages, by taking at least one or more discrete values between the minimum and maximum occulting levels.

In a variant, illustrated in FIG. 10, the faøade element 10 has been produced in such a way that it has, on the glazing unit 20, a plurality of zones 81a to 81c for which the degree of occulting may be varied separately.

Within each zone 81a to 81c, the level of occulting is uniform, but, from one zone to another, the degree of occulting may be different.

Each zone 81a to 81c extends for example over all the width of the glazing unit 20 and occupies, for example, as illustrated, approximately a third of the height thereof.

That may make it possible to vary the overall occulting of the glazing unit in a way that best preserves visual comfort, since it is for example possible to occult the top zone 81a to a maximum degree while leaving the bottom zone 81c occulted little or not at all. In this figure, also illustrated is the possibility of housing the control module 62 in the frame of the window, for example in one of the uprights thereof. It may be advantageous, if appropriate, to arrange the control module and/or the battery inside the frame, in a zone covered by a cover situated at the base of the handle, even in this cover itself. It is also possible to arrange the control module and/or the battery in a housing closed by a glazing bead. It is even possible, if appropriate, to house the battery and/or the control module in the window frame, and to provide electrical connectors allowing the connections between the different components when the window is closed.

It is possible, as illustrated in FIG. 11, to produce the window 10 in such a way that the glazing unit 20 has its degree of occulting varied only in a main zone 82a, which occupies for example most of the glazing unit 20, while a top zone 82b not covered by the electro-reactive element retains a maximum degree of clarity or is covered with a film having a degree of occulting and/or of filtering of the light that is constant.

FIG. 12A shows a faøade 3 of a building comprising at least one window 10 according to the first aspect of the invention. Such a faøade may comprise conventional glazing units 100, which are not electro-reactive, and for example electro-reactive faøade elements 110, whose occulting and/or filtering properties are controlled electrically by virtue of the energy supplied by remote photovoltaic panels, for example in the form of adjacent siding elements 120, as illustrated.

Obviously, the invention is not limited to the examples which have just been described. It is particularly possible to give the glazing units 20 and the panels 30 other forms, not rectangular and/or not planar.

Any electro-reactive element technology may be used, as may any photovoltaic technology.

1: A faøade or roofing element, including a window, characterized by the fact that it comprises:
at least one glazing unit,
at least one electro-reactive element whose optical transparency and/or light filtering properties are electrically controlled, at least partially overlapping the glazing unit,
at least one photovoltaic panel that is at least partially transparent, offset relative to the glazing unit, arranged as apron or as transom, and at least partially supplying the electrical energy necessary to the powering of the electro-reactive element, and
a crossmember separating the glazing unit from the photovoltaic panel.

2: The faøade or roofing element as claimed in claim 1, wherein the panel is arranged as apron.

3: The faøade or roofing element as claimed in claim 1, the panel being completely transparent.

4: The faøade or roofing element as claimed in claim 3, the photovoltaic panel having a transmittance of between 5 and 75%.

5: The faøade or roofing element as claimed in claim 3, the photovoltaic panel comprising photovoltaic elements that are spaced apart in frame form.

6: The faøade or roofing element as claimed in claim 1, wherein the photovoltaic panel is opaque.

7: The faøade or roofing element as claimed in claim 6, the photovoltaic panel comprising a decorative layer between the side facing outward and at least one photovoltaic element incorporated in the panel.

8: The faøade or roofing element as claimed in claim 7, wherein the decorative layer is semi-transparent.

9: The faøade or roofing element as claimed in claim 1, the expanse of the glazing unit being greater than that of the photovoltaic panel.

10: The faøade or roofing element as claimed in claim 1, the glazing unit comprising double- or triple-glazing.

11: The faøade or roofing element as claimed in claim 1, the electro-reactive element being of electrochromic type.

12: The faøade or roofing element as claimed in claim 1, the electro-reactive element being of SPD (suspended particle device) type.

13: The faøade or roofing element as claimed in claim 1, the electro-reactive element being of PDLC (polymer dispersed liquid crystal) type.

14: The faøade or roofing element as claimed in claim 1, the electro-reactive element comprising a blind, notably with slats, preferably incorporated in the glazing unit.

15: The faøade or roofing element as claimed in claim 1, the photovoltaic panel comprising double- or triple-glazing.

16: The faøade or roofing element as claimed in claim 6, the photovoltaic panel comprising a thermally insulating sheet.

17: The faøade or roofing element as claimed in claim 1, the photovoltaic panel and the glazing unit not sharing any pane.

18: The faøade or roofing element as claimed in claim 1, comprising at least one electro-reactive element arranged between two panes of the glazing unit of the faøade element.

19: The faøade or roofing element as claimed in claim 1, the photovoltaic panel comprising at least one photovoltaic element arranged between two panes.

20: The faøade or roofing element as claimed in claim 1, comprising several glazing elements and several electro-reactive elements superposed on these glazing elements.

21: The faøade or roofing element as claimed in claim 1, comprising several photovoltaic panels.

22: The faøade or roofing element as claimed in claim 1, comprising cross-pieces.

23: The faøade or roofing element as claimed in claim 1, comprising a battery for storing energy generated by the photovoltaic panel.

24: The faøade or roofing element as claimed in claim 1, comprising a wireless control module of the electro-reactive element, preferably incorporated in the glazing unit or incorporated in a frame of the faøade element.

25: The faøade or roofing element as claimed in claim 1, the electro-reactive element comprising at least two zones that are selectively occulted, the degree of occulting within each zone being uniform, and preferably the electro-reactive element comprising three such zones which, together, are preferably superposed on all of the glazing unit.

26: The faøade or roofing element as claimed in claim 1, the photovoltaic panel being used as sunlight sensor in the automatic management of the occulting of the glazing unit or of a monitoring and control system used in the thermal regulation of the building.

27: The faøade or roofing element as claimed in claim 1, comprising a control module that are controlled by a mobile terminal such as a smartphone or tablet.

28: The faøade or roofing element as claimed in claim 1, the glazing unit being between 0.2 and 10 m high.

29: The faøade or roofing element as claimed in claim 1, the electro-reactive element being able to take an occulting level chosen from among several discrete levels.

30: The faøade or roofing element as claimed in claim 1, comprising a connector making it possible to use a surplus of energy from the photovoltaic panel for other functions of the building or to return energy to the power grid.

31: The faøade or roofing element as claimed in claim 1, comprising a radio relay powered at least partially by the photovoltaic panel.

32: The faøade or roofing element as claimed in claim 1, comprising at least one electronic device such as a screen, incorporated in the glazing unit and powered by the photovoltaic panel.

33: A building faøade comprising at least one faøade element as defined in claim 1.
